(19) United States
(12) Patent Application Publication
(10) Pub. No.: US 2007/0044816 A1
(43) Pub. Date: Mar. 1, 2007

(54) HIGH-PRESSURE PROCESSING APPARATUS AND HIGH-PRESSURE PROCESSING METHOD

(76) Inventor: Kimitsugu Saito, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/462,229

(22) Filed: Aug. 3, 2006

(30) Foreign Application Priority Data
Jun. 28, 2006 (JP) 2006-177799
Aug. 23, 2005 (JP) 2005-240659

(51) Int. Cl. B08B 3/12; B08B 3/00

(52) U.S. Cl. 134/1; 134/137; 134/149

(57) ABSTRACT

Infrared light is irradiated whose wavelength corresponds to the absorption band of water contained in a chemical agent of a processing fluid introduced into inside a processing chamber of a pressure container. Only during irradiation with the infrared light, the water content of the processing fluid is selectively heated and accordingly activated. As a substrate rotates, the chemical agent on a substrate surface is sequentially activated, thereby accelerating the cleaning function of the water content of the chemical agent. This effectively removes unwanted substances (substances to be removed by cleaning) such as particles and a resist adhering to the substrate surface off from the substrate W.

### CROSS REFERENCE TO RELATED APPLICATION

The disclosure of Japanese Patent Applications enumerated below including specification, drawings and claims is incorporated herein by reference in its entirety:

No.2005-240659 filed Aug. 23, 2005; and

No.2006-177799 filed Jun. 28, 2006.

### BACKGROUND OF THE INVENTION

1. Field of the Invention

The present invention relates to a high-pressure processing apparatus and a high-pressure processing method which cleans an object-to-be-processed with a processing fluid. In the technique, it is possible to use a mixture of a high-pressure fluid and a chemical agent as the processing fluid. The processing fluid is brought into contact with a surface of an object-to-be-processed and cleans the surface of the object-to-be-processed. Objects-to-be-processed include semiconductor wafers, glass substrates for photomasks, glass substrates for liquid crystal displays, glass substrates for plasma displays, substrates for optical disks, etc.

2. Description of the Related Art

There already are proposed techniques for cleaning an object-to-be-processed such as a substrate using a low-viscosity high-dispersion supercritical fluid. Known as such a cleaning apparatus is the one described below. JP-A-2003-151896 for example describes a cleaning apparatus which, for better cleaning of an object-to-be-processed, adds a cleaning chemical agent to supercritical carbon dioxide (hereinafter referred to as “SCCO₂”). This apparatus mixes a cleaning component to SCCO₂, create a processing fluid and supplies this processing fluid to a semiconductor wafer which is an object-to-be-processed housed in a pressure container. This removes contaminants such as a resist and an etching polymer adhering to the semiconductor wafer.

### SUMMARY OF THE INVENTION

However, the conventional techniques, which require adding a chemical agent to SCCO₂ for enhanced cleaning, have the following problems. That is, while it is necessary to mix as much chemical agent as possible to SCCO₂ for improved cleaning, many cleaning chemical agents are polar substances. In the meantime, supercritical fluids such as carbon dioxide are nonpolar substances. Thus, a chemical agent will not dissolve well in a supercritical fluid. Consequently, it is difficult to mix a great amount of a chemical agent in SCCO₂.

Further, cleaning using a mixture of SCCO₂ and a chemical agent is often followed by rinsing with SCCO₂ alone, in which case an increase of the concentration of the chemical agent even within a tolerable dissolution range will result in longer rinsing and cause a problem of a lowered throughput.

An object of the invention is to provide a high-pressure processing apparatus and a high-pressure processing method with which it is possible to enhance the throughput while enhancing the effect of cleaning for a surface of an object-to-be-processed. In the invention, the object-to-be-processed is brought into contact with a processing fluid which is a mixture of a high-pressure fluid and a chemical agent.

The first aspect of the invention is directed to a high-pressure processing apparatus which uses a mixture of a high-pressure fluid and a chemical agent as a processing fluid, brings the processing fluid into contact with the surface of the object-to-be-processed and clean the surface of the object-to-be-processed, comprising a pressure container inside of which houses a processing chamber which is for cleaning, a holder which holds the object-to-be-processed inside the processing chamber, an introducer which introduces the processing fluid into inside the processing chamber and supplies the processing fluid to the surface of the object-to-be-processed, and an irradiator which irradiates the processing fluid supplied to the surface of the object-to-be-processed with infrared light whose wavelength corresponds to the absorption band of the chemical agent.

The second aspect of the invention is directed to a high-pressure processing method according to which a mixture of a high-pressure fluid and a chemical agent is used as a processing fluid which is brought into contact with a surface of an object-to-be-processed to thereby clean the surface of the object-to-be-processed, and while irradiating the processing fluid supplied to the surface of the object-to-be-processed with infrared light whose wavelength corresponds to the absorption band of the chemical agent, the surface of the object-to-be-processed is cleaned.

In the context of the invention, “a surface of an object-to-be-processed” means a surface which needs be subjected to high-pressure processing. When objects-to-be-processed are various types of substrates such as semiconductor wafers, glass substrates for photomasks, glass substrates for liquid crystal displays, glass substrates for plasma displays and substrates for optical disks and when it is necessary to treat by high-pressure processing one of the major surfaces of a substrate which mounts a circuit pattern and the like, this major surface corresponds to “the surface of the object-to-be-processed”. Meanwhile, when it is necessary to treat the other major surface through high-pressure processing, the other major surface corresponds to “the surface of the object-to-be-processed” of the invention. Of course, when it is necessary to treat by high-pressure processing the both major surfaces as in the case of a substrate whose both surfaces are mounting surfaces, the both major surfaces correspond to “the surfaces of the object-to-be-processed” of the invention.

Further, in the context of the invention, cleaning generally refers to any processing, including etching, of removing a contaminant from an object-to-be-processed. Such cleaning may for example typically be removal of particles adhering to a surface of an object-to-be-processed or separation/removal of a resist from an object-to-be-processed such as a semiconductor substrate to which the resist has adhered. Objects-to-be-processed to which contaminants have adhered include, but not limited to, semiconductor substrates, any objects in which discontinuous or continuous layers of different substances are formed or remain on substrates of various types of metal, plastic, ceramics, etc.

A high-pressure fluid used in the invention is preferably carbon dioxide, considering the safety and the price of carbon dioxide and the easiness of transforming carbon dioxide to a supercritical state. Other than carbon dioxide, a high-pressure fluid may be water, ammonia, dinitrogen monoxide, ethanol, etc. Use of a high-pressure fluid is proposed, partly because this will make it possible to disperse a dissolved contaminant in a medium due to the large dispersion coefficient of a high-pressure fluid and partly because the high-pressure fluid if further pressurized and accordingly turned into a supercritical fluid will exhibit semi-gas and semi-liquid properties and even better infiltrate even very fine patterns. In addition, a high-pressure fluid, having a density which is close to that of a liquid, can contain a far greater amount of a chemical agent than a gas can.

A high-pressure fluid referred to in relation to the invention is a fluid whose pressure is equal to or higher than 1 MPa. Preferable high-pressure fluids are such fluids which are dense and highly soluble and exhibit low viscosities and high diffusive properties. More preferable high-pressure fluids are supercritical or subcritical fluids. Carbon dioxide may be heated up to 31 degrees Celsius and pressurized up to 7.4 MPa or beyond to be transformed into a supercritical fluid (SCCO₂). Use of a subcritical fluid (high-pressure fluid) or supercritical fluid at 5 through 30 MPa is desirable particularly to a cleaning step, and it is more preferable to process at 7.4 through 30 NPa.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a drawing which illustrates an embodiment of the overall structure of the high-pressure processing apparatus according to the invention;

FIG. 2A is a drawing which shows the absorption spectrum of water;

FIG. 2B is a drawing which shows the absorption spectrum of carbon dioxide;

FIG. 3 is a drawing of a pressure container and its internal structure disposed inside the high-pressure processing shown in FIG. 1; and

FIG. 4 is a drawing which illustrates the high-pressure processing apparatus according to the invention as it is modified.

### DETAILED DESCRIPTION OF THE PREFERRED EMBODIMENTS

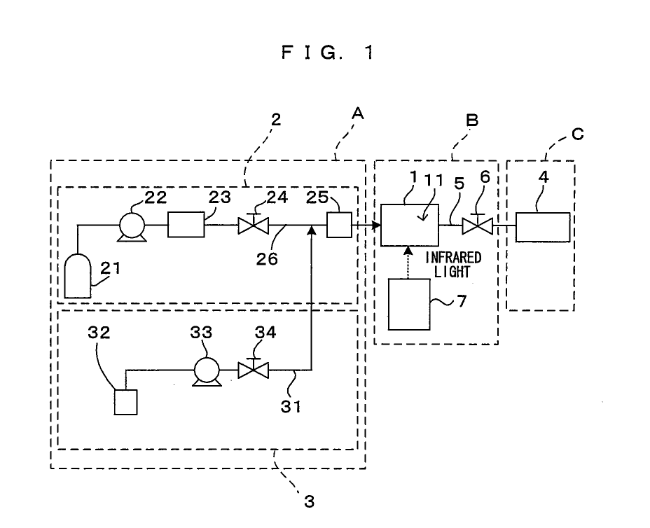

FIG. 1 is a drawing which illustrates an embodiment of the overall structure of the high-pressure processing apparatus according to the invention. This high-pressure processing apparatus is an apparatus which cleans a substrate held in a processing chamber 11. The processing chamber 11 is formed inside a pressure container 1. A mixture of supercritical carbon dioxide and a chemical agent as a processing fluid is introduced into the processing chamber 11 so as to clean the substrate which may for instance be an approximately circular semiconductor wafer. The structure and operations of this high-pressure processing apparatus will now be described in detail.

This high-pressure processing apparatus is divided generally into three units. (1) a processing fluid supply unit A which prepares the processing fluid and supplies the same to the processing chamber 11. (2) a cleaning unit B which comprises the pressure container 1, removes unwanted substances such as particles adhering to a substrate and an unnecessary resist inside the processing chamber 11 using the processing fluid. (3) a reservoir unit C which collects and holds the high-pressure fluid used for cleaning.

Of these units, the processing fluid supply unit A comprises a high-pressure fluid supply section 2 and a chemical agent supply section 3. The high-pressure fluid supply section 2 pressure-feeds supercritical carbon dioxide, i.e., SCCO₂ as the “high-pressure fluid” of the invention toward the pressure container 1. The chemical agent supply section 3 feeds an appropriate chemical agent to removal of particles, a resist, etc.

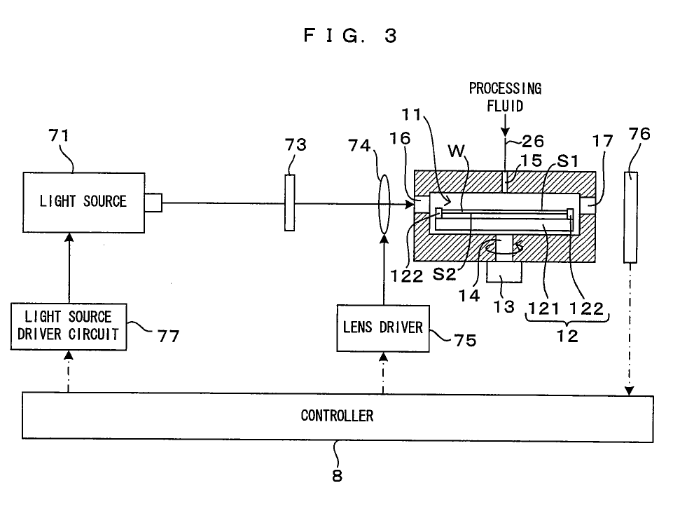

The high-pressure fluid supply section 2 comprises a high-pressure fluid reservoir tank 21 and a high-pressure pump 22. In the event that supercritical carbon dioxide is used as a high-pressure fluid as described above, it is usually liquid carbon dioxide that is stored within the high-pressure fluid reservoir tank 21. Further, a fluid may be cooled in advance in a supercooling device (not shown) for prevention of gasification inside the high-pressure pump 22. As the high-pressure pump 22 pressurizes this fluid, high-pressure liquid carbon dioxide is obtained. The output side of the high-pressure pump 22 is connected with the pressure container 1 by a high-pressure pipe 26 in which a first heater 23, a high-pressure valve 24 and a second heater 25 are interposed. The high-pressure valve 24 opens and closes in response to an open/close command received from a controller (denoted at the reference symbol 8 in FIG. 3) which controls the entire apparatus, whereby SCCO₂ is obtained and is supplied to the pressure container 1. To be more precise, high-pressure liquid carbon dioxide pressurized by the high-pressure pump 22 is fed into the first heater 23 and is heated up, so that SCCO₂ is obtained as the high-pressure fluid. And then SCCO₂ is pressure-fed directly to the pressure container 1. The high-pressure pipe 26 branches out between the high-pressure valve 24 and the second heater 25, and a branch pipe 31 is connected with a chemical agent reservoir tank 32 of the chemical agent supply section 3. The chemical agent supply section 3 feeds a chemical agent into the high-pressure pipe 26 via the branch pipe 31. As a result, SCCO₂ and the chemical agent are mixed together, whereby the processing fluid is prepared. For the purpose of precisely maintaining the temperature of the processing fluid at a process temperature, the second heater 25 heats up the processing fluid and supplies the same to the pressure container 1.

The chemical agent supply section 3 comprises the chemical agent reservoir tank 32 which stores a suitable chemical agent to removal of particles, a resist and the like as described above. It is preferable to use a basic compound as a cleaning component for such a chemical agent. This is because a basic compound hydrolyzes polymer substances often used as resists and achieves excellent cleaning. To be more specific, basic compounds may be one or more types of compounds selected from a group consisting of quaternary ammonium hydroxide, quaternary ammonium fluoride, alkylamine, alkanolamine, hydroxylamine (NH₂OH) and ammonium fluoride (NH₄F).

In the event that the solubility of a cleaning component such a basic compound in a high-pressure fluid is low, it is preferable to use a compatibilizer as a second chemical agent. The compatibilizer may serve as an assistant which makes the cleaning component dissolve or uniformly disperse in the high-pressure fluid. A compatibilizer serves also to prevent re-adhesion of a contaminant during rinsing which follows cleaning. Although not particularly limited as long as capable of compatibilizing a cleaning component with a high-pressure fluid, a compatibilizer is preferably alcohol such as methanol, ethanol and isopropanol, or alkylsulfoxide such as dimethylsulfoxide.

Hydrogen fluoride or a particular amine compound may be used for cleaning of a semiconductor wafer which seats a low dielectric constant inter-layer insulation film (low-k film). An amine compound is selected preferably from a group consisting of secondary amines and tertiary amines. An amine compound is selected more preferably from among a group consisting of 2-(methylamine) ethanol, PMDETA (pentamethyldiethylentriamine), triethanolamine, triethylamine and their mixtures.

The chemical agent reservoir tank 32 which stores such a chemical agent described above is connected with the high-pressure pipe 26 by the branch pipe 31. A feed pump 33 and a high-pressure valve 34 are interposed in the branch pipe 31. Hence, as the high-pressure valve 34 opens and closes in response to an open/close command received from the controller 8, the chemical agent inside the chemical agent reservoir tank 32 is fed into the high-pressure pipe 26, whereby the processing fluid (SCCO₂+the chemical agent) is prepared. The processing fluid is then supplied to the processing chamber 11 of the pressure container 1.

In the cleaning unit B, the pressure container 1 is linked to a reservoir section 4 of the reservoir unit C by a high-pressure pipe 5. Further, a pressure-regulating valve 6 is interposed in the high-pressure pipe 5. Hence, the processing fluid or the like inside the pressure container 1 is discharged to the reservoir section 4 as the pressure-regulating valve 6 opens, whereas as the pressure-regulating valve 6 closes, the processing fluid is locked inside the pressure container 1. In addition, as the pressure-regulating valve 6 opens and closes under control, the pressure inside the pressure container 1 is adjusted. Further, the cleaning unit B is equipped with an irradiator or irradiating section 7 which irradiates infrared light upon the processing fluid which has been introduced into inside the processing chamber 11 of the pressure container 1. The internal structure of the pressure container 1 and the specific structure of the irradiating section 7 will be described in detail later.

The reservoir section 4 of the reservoir unit C may be a vapor/liquid separator container or the like. The vapor/liquid separator container separates SCCO₂ into a gas component and a liquid component which will be individually discarded through separate routes. Alternatively, the respective components may be collected (and if necessary purified) and reused. The gas component and the liquid component separated from each other by the vapor/liquid separator container may be discharged via separate paths.

FIG. 3 is a drawing of the pressure container and its internal structure disposed inside the high-pressure processing shown in FIG. 1. A substrate holder 12 which holds a substrate W is disposed inside the processing chamber 11 of the pressure container 1. The substrate holder 12 is comprised of a holder body 121 located in the vicinity of the inner bottom part of the pressure container 1 and three support pins 122 which project toward above from the top surface of the holder body 121. By means of the three support pins 122, one substrate W is supported at its outer rim with its surface (one major surface) S to be cleaned directed toward above. A rotation shaft 14 which a motor 13 drives into rotations is linked to the holder body 121. As the motor 13 rotates, the substrate holder 12 and a substrate W held by the same rotate as one unit inside the processing chamber 11. In this embodiment, the motor 13 thus functions as the “rotator” of the invention.

Further, the pressure container 1 has a door or opening/closing section (not shown) which is for loading and unloading of a substrate W. After the substrate holder 12 has held an unprocessed substrate W following opening of the opening/closing section, cleaning is performed as described later with the opening/closing section closed. After cleaning, the opening/closing section is opened and a processed substrate W is unloaded.

Above the pressure container 1, there is an introduction inlet 15 which links to the processing chamber 11. One end of the introduction inlet 15 is positioned facing a central area of the top surface of a substrate W held by the substrate holder 12, while the other end of the introduction inlet 15 is connected with the high-pressure pipe 26. Hence, as the high-pressure valve 24 opens, the processing fluid is introduced into inside the processing chamber 11 from the high-pressure pipe or introducer 26 via the introduction inlet 15 of the pressure container 1, which then permits execution of cleaning. A side surface of the processing chamber 11 has an outlet (not shown) which links to the processing chamber 11. This outlet is connected with the reservoir section 4 via the high-pressure pipe 5, which makes it possible to discharge to outside the pressure container 1 contaminants and the like created due to cleaning processing and the processing fluid introduced to the processing chamber 11.

The irradiating section 7, for irradiation of infrared light upon the processing fluid which has been introduced into inside the processing chamber 11 in the manner described above, comprises a light source 71 which emits the infrared light. As the light source 71, this embodiment uses a light source which is capable of emitting infrared light whose wavelength corresponds to at least the absorption band of the chemical agent, to be more precise, the absorption band of the water content contained in the chemical agent. In the event that the chemical agent contains water, for activation of the water content, it is preferable to irradiate the processing fluid with infrared light whose wavelength corresponds to the absorption band of water.

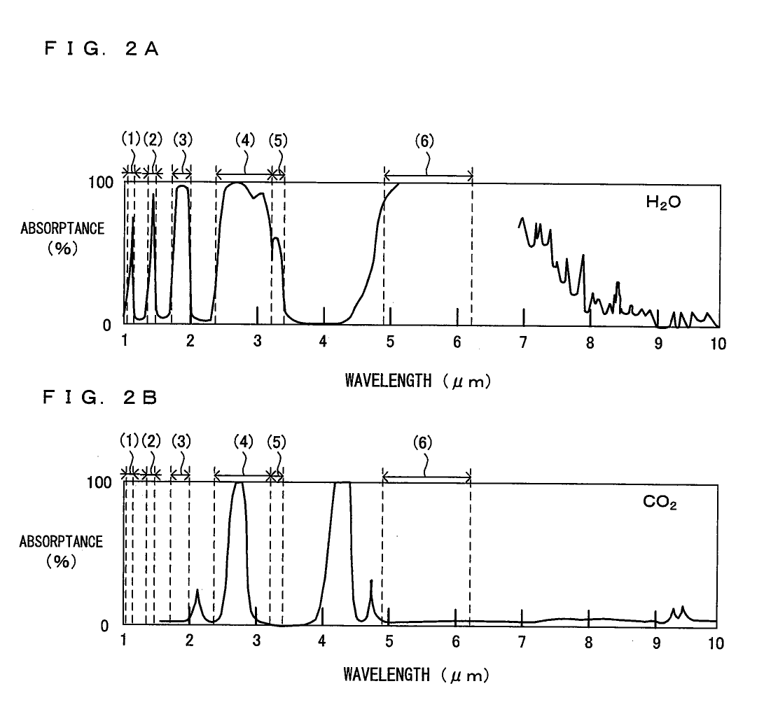

FIG. 2A is a drawing which shows the absorption spectrum of water. As FIG. 2 clearly shows, absorption bands within which the rate of absorption of water is high are, from the shorter wavelength side, (1) 1.01 μm through 1.13 μm, (2) 1.34 μm through 1.46 μm, (3) 1.70 μm through 1.98 μm, (4) 2.37 μm through 3.23 g μm, (5) 3.23 μm through 3.41 μm, and (6) 4.91 μm through 6.20 μm. It is therefore desirable that the infrared light irradiated upon the processing fluid has a wavelength belonging to either one of these absorption bands. Of these bands, the rate of absorption is relatively high within the absorption bands (2), (3), (4) and (5). Hence, when the efficiency of water activation is a high priority issue, it is desirable to use infrared light whose wavelength belongs to the absorption band (2), (3), (4) or (5). A light source emitting such infrared light may be an Nd:YAG laser (whose wavelength is 1.064 μm), an Er:YAG laser (whose wavelength is 2.94 μm), an HF laser (whose wavelength is 2.6 through 3.0 μm), a CO laser (whose wavelength is 5 through 7 μm), etc. A gas laser (an HF laser and a CO laser) has plural energy levels and therefore oscillates light which has plural wavelengths. This is why ranges are described here as the oscillation wavelength.

It is possible to use a light source which emits infrared light whose wavelength corresponds to any absorption band of water described above. That is, the light source may alternatively be any continuum light source which continuously emits infrared light or any pulse light source which pulses and emits infrared light. In this regard, use of a continuum light source is preferable for the following reason. Uninterrupted irradiation with infrared light secures a long duration of action for water activation within a predetermined period of time and accordingly improves the, throughput.

The infrared light emitted from the light source 71 is passed through an optical filter 73, converged by a condenser lens 74 and guided upon the processing fluid which has been introduced into inside the processing chamber 11 of the pressure container 1. When necessary, the optical filter 73 is disposed on an optical path so as to obtain a desired wavelength if the light emitted from the light source 71 does not have a single wavelength. A band pass filter for instance is used as the optical filter 73 of such a nature, so that it is possible to pass only light, which has a desired wavelength such the wavelength (1), (2), (3), (4), (5) or (6), out of the incident light. The light emitted from the light source 71 may contain a wavelength component corresponding to the absorption band of carbon dioxide besides a wavelength which corresponds to the absorption band of the water contained in the chemical agent. Even where the emitted light contains thus wavelength component, the wavelength component is cut off and will therefore not fall upon the processing fluid.

Further, even where the selected light source is one which emits light free from a wavelength component corresponding to the absorption band of carbon dioxide, it is still possible to selectively activate only the water contained in the chemical agent. FIG. 2B is a drawing which shows the absorption spectrum of carbon dioxide. Comparison against FIG. 2A clearly shows that a part of the absorption band (4) in FIG. 2A overlaps a wavelength region in which the rate of absorption of carbon dioxide is high (the wavelength is from 2.57 μm through 2.84 μm). Hence, when one intends to selectively activate only the water contained in the chemical agent, one may use a light source which emits light not containing a wavelength corresponding to the absorption band of carbon dioxide.

The condenser lens 74 converges the light emitted from the light source 71 and irradiates the light upon the processing fluid. This increases the energy density of the light irradiated upon the processing fluid and enhances the light intensity per unit surface area. Further, the correlation between the optical path and a pattern map of a surface SI of the substrate W may be identified in advance. An then, based on the correlation, the light may be irradiated in a concentrated manner upon an area within the surface SI where reaction needs be particularly accelerated. This will facilitate the reaction owing to the chemical agent in that area. In this embodiment, the condenser lens 74 is structured so as to be able to freely movable on the optical path, and a lens driver 75 is disposed which makes the condenser lens 74 move. Hence, as the condenser lens 74 moves in response to an operation command received from the controller 8, the focal position changes on the substrate surface S1. Further, when needed (i.e., dependent upon the installation status of each equipment), a reflecting mirror or a lens may further be disposed between the light source 71 and the condenser lens 74.

In addition, the side walls of the pressure container 1 have two optical windows 16 and 17 for the purpose of guiding the infrared light into inside the processing chamber 11 and releasing thus introduced infrared light to outside the pressure container 1. Describing in more specific details, the both side walls of the pressure container 1 located on the optical path of the infrared light emitted from the light source 71 respectively have the optical windows 16 and 17. The optical windows 16 and 17 are formed so that they transmit infrared light and are pressure-resistant. The infrared light discharged to outside the pressure container 1 is guided to a light intensity monitor 76 which then determines the absorbance of the infrared light introduced to the processing chamber 11 by the processing fluid. The light intensity monitor 76 is electrically connected with the controller 8, and the controller 8 controls a light source driver circuit 77 so that the absorbance will remain constant, whereby the output from the light source 71 is adjusted.

The operations of the high-pressure processing apparatus having the structure above will now be described. While this apparatus is in an initial state, the valves 6, 24 and 34 are all close and the pumps 22 and 33 are in a halt. As a handling apparatus, an industrial robot, a transportation mechanism or the like loads one substrate W which is an object-to-be-processed at a time into the processing chamber 11, the processing chamber 11 is closed, which completes preparation for the processing. Following this, after the high-pressure valve 24 opens, thereby making it possible to pressure-feed SCCO₂, namely, the processing fluid into the processing chamber 11, the high-pressure pump 22 activates and pressure-feeding of SCCO₂ into the processing chamber 11 starts. SCCO₂ is thus pressure-fed into the processing chamber 11, and the pressure inside the processing chamber 11 rises gradually. As the pressure-regulating valve 6 opens and closes under control in accordance with an open/close command from the controller 8 at this stage, the pressure inside the processing chamber 11 is kept constant, e.g., approximately at 20 MPa. This pressure adjustment by means of control of opening and closing continues until depressurization described later completes. Where adjustment of the temperature in the processing chamber 11 is necessary in addition, the processing chamber 11 may be set to a temperature suitable to cleaning using a heater (not shown) disposed in the vicinity of the pressure container 1.

The feed pump 33 then activates. This sends a chemical agent suitable to removal of particles, a resist and the like to the high-pressure pipe 26 from the chemical agent reservoir tank 32 via the branch pipe 31, thereby blending the chemical agent with SCCO₂ and preparing the processing fluid. As the high-pressure valve 34 opens and closes under control at this stage, the amount of the chemical agent to mix is adjusted. SCCO₂ with which the chemical agent has thus been blended is consequently introduced into inside the processing chamber 11 as the processing fluid, whereby the processing chamber 11 is filled up with the processing fluid. The motor 13 drives concurrently with this, which rotates the substrate W.

As the processing chamber 11 is filled up with the processing fluid, the controller 8 controls the light source driver circuit 77 so that the light source 71 emits infrared light toward the processing chamber 11. The infrared light introduced into inside the processing chamber 11 is converged upon the processing fluid while propagating over the substrate W approximately parallel to the surface S1 of the substrate W. Since the irradiated infrared light has a wavelength which corresponds to the absorption band of the water contained in the chemical agent, the water contained in the chemical agent absorbs a part of the infrared light and the water contained in the chemical agent gets locally heated. This activates the chemical agent immediately above the surface S1 of the substrate, i.e., intensifies the cleaning function of the water contained in the chemical agent. Consequently, the processing fluid effectively removes off from the substrate W unwanted substances (substances to be removed by cleaning) such as particles and a resist adhering to the surface S1 of the substrate. On top of this, rotations of the substrate W sequentially activate the chemical agent immediately above the surface S1, and the cleaning function acts upon the substrate surface S1 at various places of the substrate surface S1. It is thus possible to bring the activated chemical agent into contact with the entire substrate surface S1 and evenly clean the substrate surface as a whole due to this excellent cleaning effect. The processing fluid carrying the unwanted substances is fed to the reservoir section 4 of the reservoir unit C via the high-pressure pipe 5.

In this embodiment, the light source emits light which does not contain a wavelength corresponding to the absorption band of carbon dioxide, or the optical filter 73 blocks light whose wavelength corresponds to the absorption band of carbon dioxide. Hence, carbon dioxide contained in the processing fluid scarcely absorbs the infrared light which has been guided into the processing chamber 11. As a result, merely the water contained in the chemical agent is activated only during irradiation with the infrared light while maintaining the temperature of the entire processing fluid inside the processing chamber 11 unchanged.

Upon completion of cleaning, the high-pressure valve 34 is closed, the feed pump 33 is stopped, and the light source 71 stops irradiating the infrared light. This terminates supply of the chemical agent. However, SCCO₂ is kept fed under pressure, thereby executing SCCO₂ rinsing with SCCO₂ alone supplied into the processing chamber 11. Although this embodiment requires executing rinsing only with SCCO₂, rinsing may be performed with an alcohol component, such as methanol, which is mixed with SCCO₂. In the event of executing the rinsing with mixed rinse solution (SCCO₂+alcohol component), a final rinsing may be additionally performed with SCCO₂ alone.

Upon completion of rinsing, the high-pressure pump 22 is stopped, which stops pressure-feeding of SCCO₂. The internal pressure inside the processing chamber 11 then returns back to the normal pressure, as the pressure-regulating valve 6 opens and closes under control. SCCO₂ remaining inside the processing chamber 11 evaporates as gas during this depressurization, which makes it possible to dry the substrate W without causing any inconvenience such as a stain on the substrate W. Once the processing chamber 11 has returned back to the normal pressure, the processing chamber 11 opens, and a handling apparatus, an industrial robot, a transportation mechanism or the like unloads thus cleaned substrate W. The operation described above is repeated as a next unprocessed substrate W arrives.

As described above, since the processing fluid supplied to the substrate W is irradiated with the infrared light whose wavelength corresponds to the absorption band of water contained in the chemical agent according to this embodiment, the water contained in the processing fluid is locally heated and activated. This permits a relatively small amount of the chemical agent mixed in SCCO₂ to improve the speed of the reaction caused by the chemical agent and enhance the effect of cleaning. In addition, as the amount of the chemical agent used is reduced, the time required for rinsing becomes shorter, thereby improving the throughput. Further, since the chemical agent is activated only during irradiation with light, the reaction makes a dominant progress and the process controllability of the reaction time improves.

Further, the structure according to this embodiment prohibits irradiation of the processing fluid with infrared light whose wavelength corresponds to the absorption band of carbon dioxide. Hence, it is possible to prevent attenuation of the infrared light due to absorption of the infrared light by carbon dioxide contained in the processing fluid before arrival of the infrared light at a location near the substrate W. This makes it possible to selectively activate only the chemical agent component. And this effectively enhances the cleaning function while making a maximum use of the irradiated light and maintaining the temperature of the processing fluid as a whole inside the processing chamber 11, that is, without impairing the process controllability.

Further, since this embodiment requires irradiating the infrared light upon the processing fluid guided into inside the processing chamber 11, it is possible to directly activate the chemical agent immediately above the substrate W (object-to-be-processed), which works to an advantage in enhancing the cleaning effect.

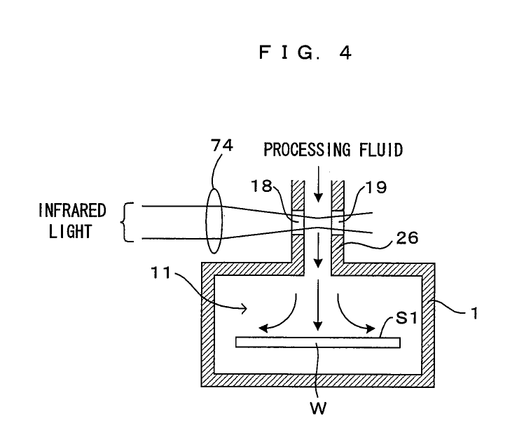

The invention is not limited to the embodiments described above but may be modified in various manners besides the embodiment above, to the extent not deviating from the object of the invention. For instance, although the embodiment described above requires irradiating the infrared light upon the processing fluid guided into inside the processing chamber 11 of the pressure container 1, this is not limiting. Alternatively, optical windows 18 and 19 may be disposed to the high-pressure pipe 26 (which corresponds to the “introducing pipe” of the invention), and infrared light may be converged on the processing fluid which flows inside the high-pressure pipe 26 as shown in FIG. 4 for instance. To be more precise, the infrared light is converged on the processing fluid in a direction which is approximately orthogonal to the flowing direction of the processing fluid so that the infrared light will not impinge upon the substrate surface S1. In such a structure, a chemical agent component activated inside the high-pressure pipe 26 reaches a substrate W via the processing fluid which flows into the processing chamber 11. This permits the activated chemical agent component effectively remove unwanted substances (substances to be removed by cleaning) adhering to the substrate W, as in the embodiment described above. This structure brings about the additional advantage described below. It is desirable that the pressure container 1, which houses a substrate W to be processed, has a simple structure of the minimum necessary volume considering the amount of the processing fluid to use and the cleaning effect. This structure realizes improvement of the cleaning effect without modifying the pressure container 1.

Further, the embodiment above requires activating water contained in the chemical agent by means of irradiation with the infrared light whose wavelength corresponds to the absorption band of the water contained in the chemical agent. Alternatively, in the event that the chemical agent does not contain water, irradiation with infrared light whose wavelength corresponds to the absorption band of a cleaning component (other than water) contained in the chemical agent may activate the cleaning component. This structure as well realizes a similar effect to that according to the embodiment described above.

Further, the structure according to this embodiment prohibits irradiation of the processing fluid with infrared light whose wavelength corresponds to the absorption band of carbon dioxide. Alternatively, the processing fluid may be irradiated with such infrared light having a wavelength which, even though corresponding to the absorption band of carbon dioxide, does not obstruct activation of a chemical agent component. In short, when heating of the entire processing fluid introduced into inside the processing chamber 11 will cause no problem as a process, both SCCO₂ and the chemical agent may be activated. However, use of a continuum light source as the light source is preferable for this. The reason is that use of a pulse light source for this, although dependent upon the concentration of the chemical agent, could result in deposition of the chemical agent dissolved in SCCO₂ as the concentration of SCCO₂ accounting for a dominant portion of the processing fluid changes.

In the event that the chemical agent contains no water and a chemical agent component needs be activated without affecting carbon dioxide, such a light source may be used whose wavelength corresponds to the absorption band of the chemical agent component but is outside the absorption band of carbon dioxide.

Further, although the embodiment described above requires that the support pins 122 of the substrate holder 12 support a substrate W at the outer rim of the substrate W, the method of holding the substrate W is not limited to this. For cleaning of the substrate surface S1 for example, the substrate W may be supported as it is sucked at its bottom surface (other major surface) S2.

Further, although the embodiment described above requires introducing the processing fluid into inside the processing chamber 11 from above the pressure container 1 and accordingly supplying the processing fluid approximately perpendicularly to the substrate surface S1, the method of introducing the processing fluid is not limited to this. For instance, the processing fluid may be introduced into inside the processing chamber 11 from the side of the pressure container 1 and accordingly supplied to the substrate surface S1 approximately parallel.

Further, although the embodiment described above requires irradiating infrared light over the major surface S1, one of the two major surfaces of a substrate W, with the major surface S1 directed toward above, the infrared light may be irradiated over the other major surface S2 of the substrate W with the other major surface S2 directed toward above.

Further, although the embodiment described above is directed to the application of the invention to a single wafer type processing apparatus which processes one substrate W at a time, the invention is applicable also to a processing apparatus of the so-called batch type which processes multiple substrates W simultaneously.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A high-pressure processing apparatus which brings a mixture of a high-pressure fluid and a chemical agent, which is used as a processing fluid, into contact with a surface of an object-to-be-processed to thereby clean this surface of the object-to-be-processed, comprising:
a pressure container which has a processing chamber which is for cleaning;
a holder which holds the object-to-be-processed inside the processing chamber;
an introducer which introduces the processing fluid into inside the processing chamber and supplies the processing fluid to the surface of the object-to-be-processed; and
an irradiator which irradiates the processing fluid supplied to the surface of the object-to-be-processed with infrared light whose wavelength corresponds to the absorption band of the chemical agent.

2. The high-pressure processing apparatus of claim 1, further comprising a rotator which rotates the object-to-be-processed which is held by the holder.

3. The high-pressure processing apparatus of claim 1, wherein the chemical agent contains water, and
the irradiator comprises a light source which emits infrared light whose wavelength corresponds at least to the absorption band of water.

4. The high-pressure processing apparatus of claim 3, wherein the light source of the irradiator emits infrared light having a wavelength which falls under any one of the ranges of 1.01 μm through 1.13 μm, 1.34 μm through 1.46 μm, 1.70 μm through 1.98 μm, 2.37 μm through 3.23 μm, 3.23 μm through 3.41 μm, and 4.91 μm through 6.20 μm.

5. The high-pressure processing apparatus of claim 3, wherein the high-pressure fluid is high-pressure carbon dioxide, and
the irradiator further comprises an optical filter which is capable of blocking infrared light whose wavelength corresponds to the absorption band of carbon dioxide, and the light emitted from the light source irradiates the processing fluid via the optical filter.

6. The high-pressure processing apparatus of claim 3, wherein the irradiator further comprises a condenser lens which converges the light emitted from the light source and irradiates the processing fluid with the light.

7. The high-pressure processing apparatus of claim 1, wherein the pressure container comprises an optical window which transmits the infrared light, and
the irradiator irradiates, through the optical window, the infrared light upon the processing fluid introduced into inside the processing chamber.

8. The high-pressure processing apparatus of claim 1, wherein the introducer includes an introducing pipe which has an optical window transmitting the infrared light and is connected with the pressure container, and
the irradiator irradiates, through the optical window, the infrared light upon the processing fluid flowing inside the introducing pipe.

9. The high-pressure processing apparatus of claim 3, wherein the light source is any one of an Nd:YAG laser, an Er:YAG laser, an HF laser and a CO laser.

10. The high-pressure processing apparatus of claim 3, wherein the light source is a non-dispersive infrared lamp.

11. A high-pressure processing method which brings a mixture of a high-pressure fluid and a chemical agent, which is used as a processing fluid, into contact with a surface of an object-to-be-processed to thereby perform cleaning of this surface of the object-to-be-processed, wherein
while irradiating infrared light whose wavelength corresponds to the absorption band of the chemical agent upon the processing fluid which is supplied to this surface of the object-to-be-processed, the cleaning of this surface of the object-to-be-processed is realized.

12. The high-pressure processing method of claim 11, wherein the chemical agent contains water, and
the cleaning is realized while irradiating infrared light whose wavelength corresponds to the absorption band of water upon the processing fluid.

13. The high-pressure processing method of claim 11, wherein the chemical agent contains water, and
the infrared light has a wavelength which falls under any one of the ranges of 1.01 μm through 1.13 μm, 1.34 μm through 1.46 μm, 1.70 μm through 1.98 μm, 2.37 μm through 3.23 μm, 3.23 μm through 3.41 μm, and 4.91 μm through 6.20 μm.

14. The high-pressure processing method of claim 11, wherein a light source of the infrared light is any one of an Nd:YAG laser, an Er:YAG laser, an HF laser and a CO laser.

15. The high-pressure processing method of claim 11, wherein a light source of the infrared light is a non-dispersive infrared lamp.

16. The high-pressure processing method of claim 11, wherein the cleaning is performed while rotating the object-to-be-processed.
